(19) United States
(12) Patent Application Publication
(10) Pub. No.: US 2019/0210597 A1
(43) Pub. Date: Jul. 11, 2019

(54) VEHICLE CONTROL APPARATUS

(71) Applicant: DENSO CORPORATION, Kariya-city, Aichi-pref. (JP)

(72) Inventors: Yasuhiko MUKAI, Kariya-city, Aichi-pref. (JP); Noriyasu NOTO, Kariya-city, Aichi-pref. (JP); Tetsuya TOKUDA, Kariya-city, Aichi-pref. (JP); Masanobu YAMAGUCHI, Kariya-city, Aichi-pref. (JP)

(21) Appl. No.: 16/327,097

(22) PCT Filed: Aug. 24, 2017
(86) PCT No.: PCT/JP2017/030347

§ 371 Date: Feb. 21, 2019

(30) Foreign Application Priority Data
Aug. 24, 2016 (JP) 2016-163907

(51) Int. Cl. B60W 30/09; B60W 10/20; B60W 10/18; B60W 50/00

(52) U.S. Cl. CPC B60W 30/09; B60W 10/20; B60W 10/18; B60R 16/033; B60W 2710/18; B60W 2710/20; B60W 50/0097

(57) ABSTRACT

An avoidance control unit performs, as collision-avoidance control for causing an object that exists ahead of an own vehicle and the own vehicle to avoid a collision with each other, one or both of automatic steering control for changing a traveling direction of the own vehicle by controlling a steering device of the own vehicle, and automatic braking control for reducing a traveling speed of the own vehicle by controlling a braking device of the own vehicle. A situation determination unit determines whether a low-friction situation, which is a situation where a road-surface frictional coefficient of a road on which the own vehicle becomes low, has occurred. A changing unit causes the avoidance control unit to start the collision avoidance control at an earlier timing at a time when the situation determination unit determines that the low-friction situation has occurred than a timing at a time when the situation determination unit determines that the low-friction situation has not occurred.

### CROSS REFERENCE TO RELATED APPLICATIONS

The present international application claims the priority of Japanese Patent Application No. 2016-163907 filed in Japan Patent Office on Aug. 24, 2016, and the entire contents of Japanese Patent Application No. 2016-163907 are incorporated herein by reference.

### TECHNICAL FIELD

The present disclosure relates to a vehicle control apparatus that controls a vehicle such that the vehicle avoids a collision with an object that exists ahead of the vehicle.

### BACKGROUND ART

For example, Patent Literature 1 below discloses a control apparatus that performs automatic braking and automatic steering such that a vehicle avoids a collision with a forward object that exists ahead of the vehicle. The automatic braking refers to automatic braking of the vehicle performed by controlling a braking device. The automatic steering refers to automatic change of the traveling direction of the vehicle performed by controlling a steering device.

### CITATION LIST

### Patent Literature

### [PTL 1]

JP 5-58319 A

### SUMMARY OF THE INVENTION

Through intensive studies, the inventors have found the following problem. As a road-surface frictional coefficient becomes lower, a distance until the vehicle is stopped after a start of the automatic braking (that is, braking distance) becomes longer. Similarly, a period that is necessary for moving the vehicle in a lateral direction by a predetermined distance after a start of the automatic steering becomes longer.

Thus, in the case where the road-surface frictional coefficient is low, even when the automatic braking or the automatic steering is started at a normal timing, an advantage of the collision avoidance may not be sufficiently obtained.

It is desired that a technology for inhibiting impairment of the advantage of collision avoidance be provided according to an aspect of the present disclosure.

According to an aspect of the present disclosure, there is provided a vehicle control apparatus including an avoidance control unit, a situation determination unit, and a changing unit.

The avoidance control unit performs, as collision-avoidance control for causing an object that exists ahead of an own vehicle and the own vehicle to avoid a collision with each other, one or both of automatic steering control and automatic braking control. The own vehicle refers to a vehicle in which the vehicle control apparatus is installed. The automatic steering control refers to control for changing a traveling direction of the own vehicle by controlling a steering device of the own vehicle. The automatic braking control refers to braking for reducing a traveling speed of the own vehicle by controlling a braking device of the own vehicle.

The situation determination unit determines whether a low-friction situation, which is a situation where a road-surface frictional coefficient of a road on which the own vehicle is traveling becomes low, has occurred.

The changing unit causes the avoidance control unit to start the collision avoidance control at an earlier timing at a time when the situation determination unit determines that the low-friction situation has occurred than a timing at a time when the situation determination unit determines that the low-friction situation has not occurred.

With such a configuration, in the situation where the road-surface frictional coefficient becomes low, the collision avoidance control is started at the earlier timing. Thus, an advantage of the collision avoidance can be inhibited from being impaired by the decrease of the road-surface frictional coefficient.

Note that, the parenthesized reference symbols described in the claims represent correspondences to the specific means described in the embodiments as an example hereinbelow, and do not limit the technical scope of the present disclosure.

### BRIEF DESCRIPTION OF THE DRAWINGS

FIG. 1 is a block diagram showing a configuration of a collision avoidance apparatus and devices connected to the collision avoidance apparatus.

FIG. 2 is a flowchart showing a collision avoidance process according to a first embodiment.

FIG. 3 is a view illustrating a situation where a bicycle is about to run out in front of a traveling own vehicle.

FIG. 4 is a diagram for illustrating a method of determining an own-vehicle collision risk.

FIG. 5 is a diagram for illustrating a method of calculating a lateral avoidance amount.

FIG. 6 is a diagram for illustrating a method of determining an avoidance operation and a normal region map.

FIG. 7 is a diagram for illustrating a changing process.

FIG. 8 is a flowchart showing a collision avoidance process according to a second embodiment.

FIG. 9 is a flowchart showing a collision avoidance process according to a modification.

### DESCRIPTION OF EMBODIMENTS

Hereinafter, embodiments of the present disclosure will be described with reference to the drawings.

### 1. First Embodiment

### [1-1. Configuration]

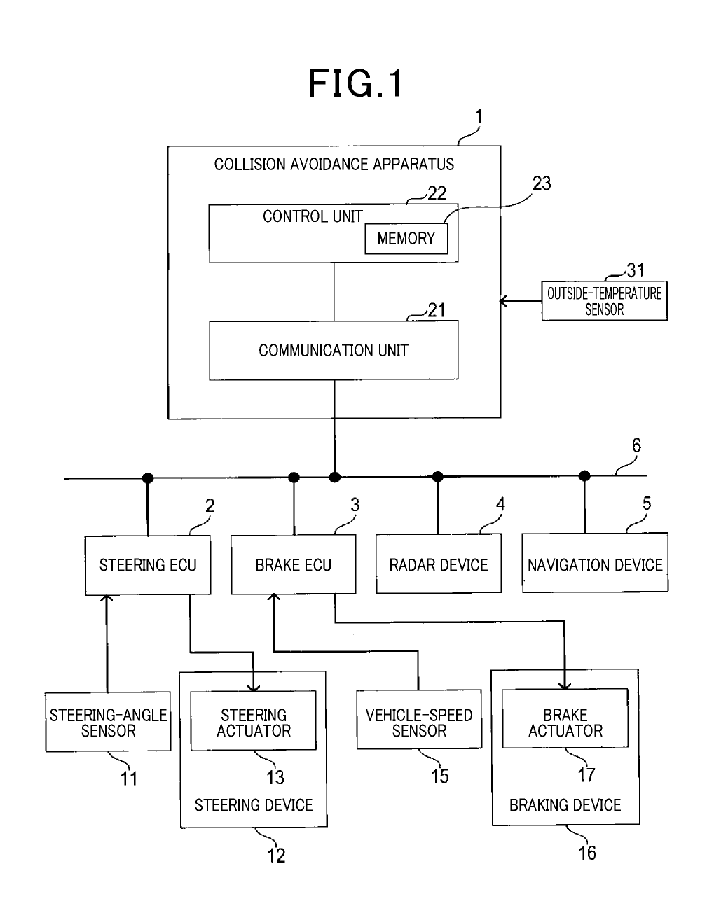

A collision avoidance apparatus 1 according to this embodiment, which is shown in FIG. 1, corresponds to a vehicle control apparatus. The collision avoidance apparatus 1 is installed in a vehicle.

As shown in FIG. 1, the collision avoidance apparatus 1 is connected to a steering ECU 2, a brake ECU 3, a radar device 4, and a navigation device 5 via a communication line 6 so as to be capable of data communication with each other. Note that, the ECU is an abbreviation of “Electronic Control Unit,” that is, an abbreviation of an electronic control unit. Further, the vehicle in which the collision avoidance apparatus 1 is installed is referred to as an own vehicle.

A detected signal from a steering-angle sensor 11 is input to the steering ECU 2. The steering-angle sensor 11 detects a steering angle of front wheels at a time when a driver performs a steering operation. In response to the detection signal from the steering-angle sensor 11, the steering ECU 2 performs power-steering control for generating an assisting force at a time when the steering angle of the steered wheels is changed. The steering operation is specifically an operation of a steering wheel.

Further, the steering ECU 2 controls a steering device (that is, steering) 12 of the own vehicle based on a steering-control data item (such as change amount of the steering angle) that is transmitted from the collision avoidance apparatus 1 via the communication line 6, thereby controlling the steering angle of the own vehicle. Specifically, the steering ECU 2 drives a steering actuator 13 provided in the steering device 12, thereby controlling the steering angle of the own vehicle via the steering device 12. The steering actuator 13 includes a motor that applies an operational force to the steering device 12.

The brake ECU 3 performs, for example, ABS control and traction control in response to a detection signal from a vehicle-speed sensor 15 and to detection signals from other sensors. The vehicle-speed sensor 15 detects a traveling speed of the own vehicle. The other sensors include a master-cylinder pressure sensor that detects a brake operation amount from an oil pressure of a master cylinder for pumping a brake oil.

Further, the brake ECU 3 controls a braking device (that is, brakes) 16 of the own vehicle based on a brake-control data item (such as deceleration) that is transmitted from the collision avoidance apparatus 1 via the communication line 6, thereby controlling a braking force of the own vehicle. Specifically, the brake ECU 3 drives a brake actuator 17 provided to the braking device 16, thereby controlling the braking force of the own vehicle, which is generated by the braking device 16. The brake actuator 17 includes solenoids that open/close hydraulic paths for applying the oil pressure to respective brake calipers of a plurality of wheels of the own vehicle.

The radar device 4 transmits radar waves forward from the own vehicle, and receives reflected ones of the radar waves, thereby detecting a position of an object that exists ahead of the own vehicle (that is, forward object).

The navigation device 5 acquires a map data item from a map storage medium in which road-map data items and various other information items are stored, and detects a current position of the own vehicle based on, for example, GPS signals received via a GPS antenna (not shown). GPS is an abbreviation of “Global Positioning System.”

Further, the navigation device 5 performs, for example, control for displaying the current position of the own vehicle on a display screen, and control for providing route guidance from the current position to a destination. In addition, the navigation device 5 also has a wireless communication function of receiving various information items that are transmitted in a wireless manner from information providers such as a terrestrial broadcaster.

The collision avoidance apparatus 1 includes a communication unit 21 and a control unit 22.

The communication unit 21 transmits and receives data items by using a preset communication protocol with respect to the devices connected to the communication line 6. The communication protocol is, for example, CAN, but other protocols may be employed. Note that, CAN is an abbreviation of “Controller Area Network.” In addition, CAN is a registered trademark.

The control unit 22 includes a microcomputer including a semiconductor memory (hereinafter, memory) 23 such as a RAM, a ROM, or a flash memory, and a CPU. With this, the control unit 22 executes various processes in accordance with a program stored in the memory 23. In other words, various functions of the control unit 22 are exerted when the CPU executes the program stored in a non-transitory solid-state recording medium. In this example, the memory 23 corresponds to the non-transitory tangible storage medium storing the program. Further, when this program is executed, a method corresponding to the program is carried out.

Note that, the control unit 22 may include the single microcomputer, or may include a plurality of microcomputers. Further, part or the entirety of the control unit 22 may be constituted by one or a plurality of hardware modules. For example, when the part or the entirety of the control unit 22 is constituted by an electronic circuit which is hardware, this electronic circuit may be constituted by a digital circuit including a large number of logic circuits, or an analog circuit, or by a combination of a digital circuit and an analog circuit.

Further, a detected signal from an outside-temperature sensor 31 provided to the own vehicle is input to the collision avoidance apparatus 1. The outside-temperature sensor 31 is a sensor that detects an outside temperature which is a temperature on the outside of the own vehicle. The outside-temperature sensor 31 outputs a signal of a voltage in accordance with the outside temperature as the detection signal. Then, the control unit 22 performs A/D conversion of the detection signal from the outside-temperature sensor 31, thereby acquiring the outside temperature. Note that, the configuration in which the control unit 22 acquires the outside temperature detected by the outside-temperature sensor 31 may be replaced with another configuration. For example, there may be employed a configuration in which the control unit 22 acquires a result of the detection of the outside temperature by the outside-temperature sensor 31 via the communication line 6.

### [1-2. Process]

In the collision avoidance apparatus 1, the control unit 22 executes a collision avoidance process. The collision avoidance process is repeatedly executed at preset execution intervals (for example, 50 ms) during an operation of the control unit 22.

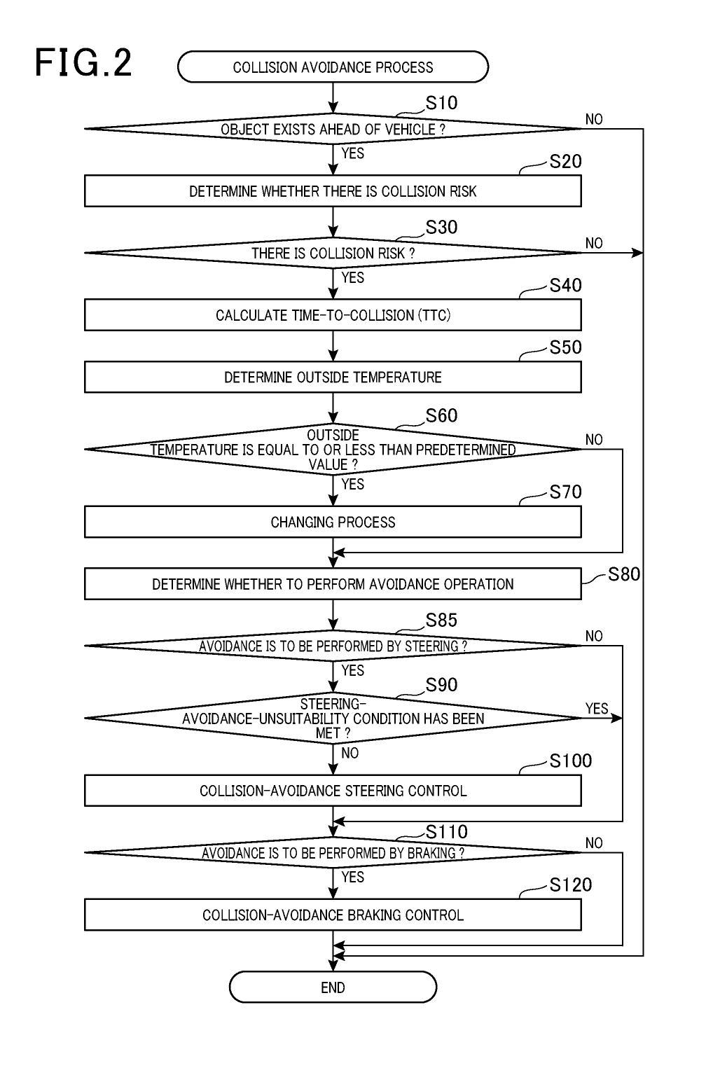

As shown in FIG. 2, when the control unit 22 starts the collision avoidance process, first, in S10, the control unit 22 determines, based on a result of detection by the radar device 4, whether a forward object exists. When the control unit 22 determines in S10 that no forward object exists, the control unit 22 temporarily ends the collision avoidance process.

Meanwhile, when the control unit 22 determines in S10 that the forward object exists, the control unit 22 advances the process to S20, and then determines whether there is a risk that the forward object and the own vehicle collide with each other (hereinafter, referred to as own-vehicle collision risk).

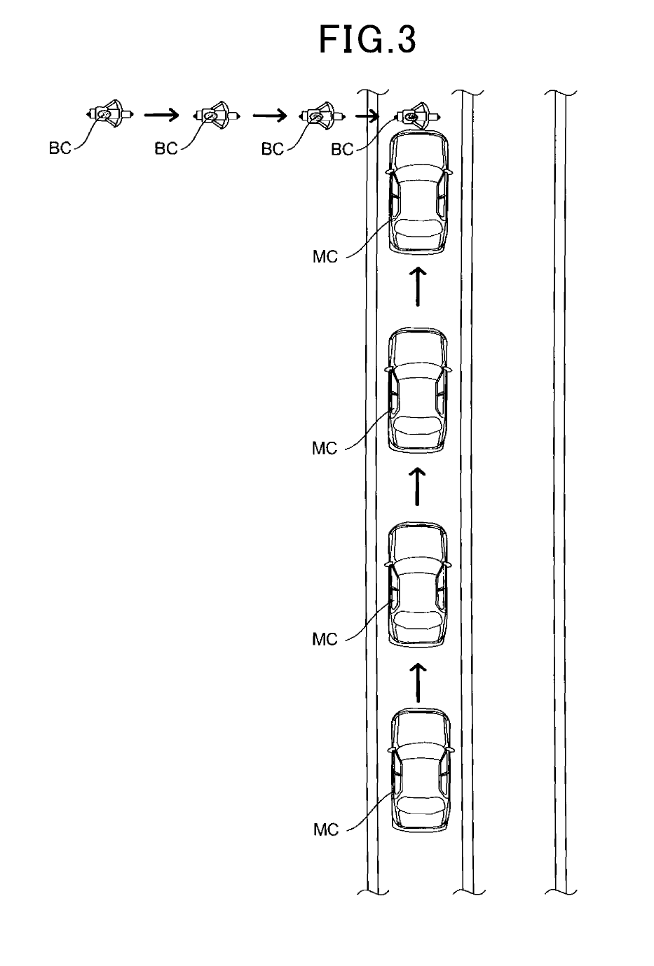

A method by which the control unit 22 determines whether there is the own-vehicle collision risk will be described by way of an example of a situation illustrated in FIG. 3. FIG. 3 illustrates a situation where, ahead of a traveling own vehicle MC, a bicycle BC is about to run out from the left-hand side of the own vehicle MC.

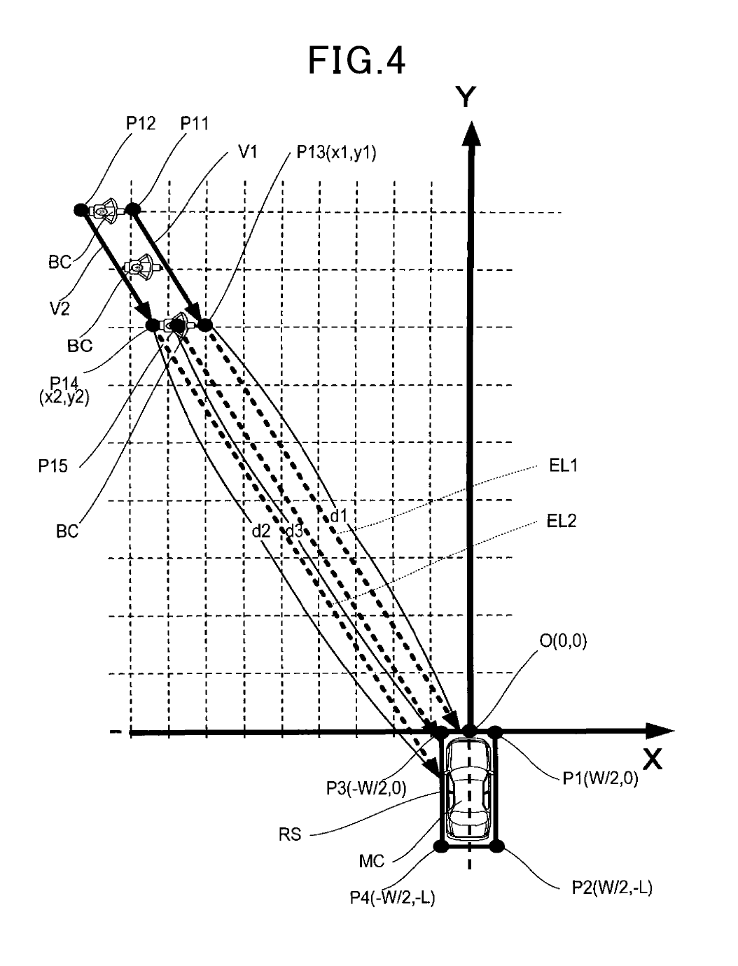

First, as shown in FIG. 4, the front-back direction of the own vehicle is defined as a Y-axis, the direction perpendicular to the front-back direction of the own vehicle is defined as an X-axis, and in addition, a two-dimensional orthogonal coordinate system with an origin O corresponding to a front-end central portion of the own vehicle is set. Coordinates of the origin O are defined as “(0, 0).”

When the overall width of the own vehicle is W, and the overall length of the own vehicle is L, the own vehicle exists in a range corresponding to a rectangle RS with corners corresponding to the following four points P1 to P4. Point P1 is a point corresponding to coordinates “(W/2, 0).” Point P2 is a point corresponding to coordinates “(W/2, −L).” Point P3 is a point corresponding to coordinates “(−W/2, 0).” Point P4 is a point corresponding to coordinates “(−W/2, −L).”

Then, based on the result of the detection by the radar device 4 at a time when a previous collision-avoidance process is executed, and on the result of the detection by the radar device 4 at a time when a current collision-avoidance process is executed, the control unit 22 calculates relative-speed vectors of a right-hand end portion and a left-hand end portion of the bicycle BC. Note that, in the example of FIG. 4, the right-hand end portion of the bicycle BC is a front end portion of the bicycle BC, and the left-hand end portion of the bicycle BC is a rear end portion of the bicycle BC. For example, positions of the right-hand end portion and the left-hand end portion of the bicycle BC at the time when the previous collision-avoidance process is executed are defined as a point P11 and a point P12, respectively. Further, positions of the right-hand end portion and the left-hand end portion of the bicycle BC at the time when the current collision-avoidance process is executed are defined a point P13 and a point P14, respectively. In this case, a relative-speed vector V1 of the right-hand end portion of the bicycle BC is calculated by subtracting coordinate values of the point P11 from coordinate values of the point P13. Similarly, a relative-speed vector V2 of the left-hand end portion of the bicycle BC is calculated by subtracting coordinate values of the point P12 from coordinate values of the point P14.

Then, when the rectangle RS representing the range in which the own vehicle exists is located on an extension line EL1 of the relative-speed vector V1 from the point P13 representing a current position of the right-hand end portion of the bicycle BC, the control unit 22 determines that there is the own-vehicle collision risk.

Specifically, first, the control unit 22 calculates an intersection of the extension line EL1 of the relative-speed vector V1 from the right-hand end portion of the bicycle BC and the X-axis.

When coordinates of the right-hand end portion of the bicycle BC (that is, point P13) are “(x1, y1),” and when a slope of the relative-speed vector V1 is “a,” the extension line EL1 is expressed by the following equation (1). Note that, “a=dy/dx” is established.

y=a×(x−x1)+y1 (1)

Thus, as expressed by the following equation (2), a value of “x” at a time when “y=0” is established in the equation (1) is calculated as an x-coordinate value of the intersection with the X-axis.

0=a×(x−x1)+y1 (2)

Further, from the equation (2), the x-coordinate value of the intersection with the X-axis can be expressed as the following equation (3).

x=−y1/a+x1 (3)

When this x-coordinate value falls within a range more than −W/2 and less than +W/2, the control unit 22 determines that there is the own-vehicle collision risk. Then, the control unit 22 calculates a distance (hereinafter, referred to as right-hand-end-portion collision distance) d1 between the right-hand end portion of the bicycle BC (that is, point P13) and an intersection with the own vehicle MC (that is, rectangle RS) from the following equation (4).

$$d 1 = {\{ y {1}^{2} + {( y 1 / a )}^{2} \}}^{- 1 / 2} = {( 1 + 1 / {a}^{2} )}^{- 1 / 2} \times y 1 \qquad ( 4 )$$

Further, the control unit 22 calculates an intersection of the extension line EL1 of the relative-speed vector V1 from the right-hand end portion of the bicycle BC and a left-hand side of the rectangle RS.

As expressed by the following equation (5), a value of “y” at a time when “x=−W/2” is established in the equation (1) is calculated as a y-coordinate value of the intersection with the left-hand side of the rectangle RS.

y=a×(−W/2−x1)+y1 (5)

When this y-coordinate value falls within a range more than −L and less than 0, the control unit 22 determines that there is the own-vehicle collision risk. Then, the control unit 22 calculates the right-hand-end-portion collision distance d1 at this time from the following equation (6).

d1=[(x1+w/2)²+{2xyl+a(w/2−x1)}²]^{-1/2} (6)

Next, the control unit 22 calculates, as with respect to the extension line EL1, an intersection of an extension line EL2 of the relative-speed vector V2 from the left-hand end portion of the bicycle BC and the X-axis, and an intersection of the extension line EL2 and the left-hand side of the rectangle RS, thereby determining the own-vehicle collision risk. Then, when the control unit 22 determines that there is the own-vehicle collision risk, as with respect to the extension line EL1, the control unit 22 calculates a distance d2 (hereinafter, referred to as left-hand-end-portion collision distance d2) between the left-hand end portion of the bicycle BC (that is, point P14) and an intersection with the own vehicle MC. Note that, in FIG. 4, coordinates of the point P14 are “(x2, y2).”

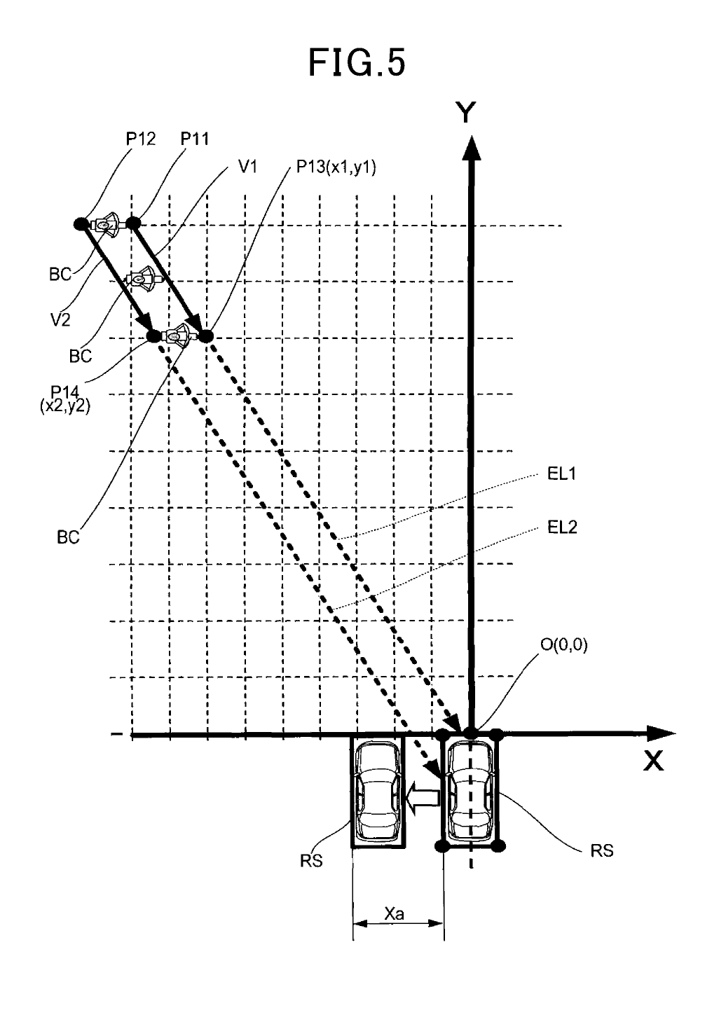

Further, when the control unit 22 determines that there is the own-vehicle collision risk, the control unit 22 calculates a moving amount (hereinafter, referred to as lateral avoidance amount) Xa by which, as shown in FIG. 5, the rectangle RS is moved along the X-axis direction such that the extension lines EL1 and EL2 and the rectangle RS do not intersect with each other.

Then, after the control unit 22 ends the process of S20, as shown in FIG. 2, in S30, the control unit 22 determines, based on the result of the determination in S20, whether there is the own-vehicle collision risk. When the control unit 22 determines in S30 that there is the own-vehicle collision risk, the control unit 22 temporarily ends the collision avoidance process.

In contrast, when the control unit 22 determines in S30 that there is the own-vehicle collision risk, the control unit 22 advances the process to S40, and then calculates a time-to-collision TTC which is a predictive value of a time period until the collision between the own vehicle and the forward object. Note that, TTC is an abbreviation of “Time To Collision.”

A method by which the control unit 22 calculates the time-to-collision TTC will be described by way of the example of the above-described situation illustrated in FIG. 3.

First, as shown in FIG. 4, the control unit 22 calculates the right-hand-end-portion collision distance d1, the left-hand-end-portion collision distance d2, and a central-portion collision distance d3. Note that, the right-hand-end-portion collision distance d1 and the left-hand-end-portion collision distance d2 have already been calculated in the process of S20. The central-portion collision distance d3 is a distance between a central portion of the bicycle BC, which is represented by a point P15 in FIG. 4, and an intersection with the own vehicle MC (that is, rectangle RS). In S40, the control unit 22 calculates the central-portion collision distance d3 by a method similar to those for the right-hand-end-portion collision distance d1 and the left-hand-end-portion collision distance d2.

Further, the control unit 22 calculates a speed V_{B} of the bicycle BC from the following equation (7).

V_{B}={(dx/dt)²+(dy/dt)²}^{-1/2} (7)

Then, the control unit 22 calculates a time-to-collision TTC1 of the right-hand end portion of the bicycle BC, a time-to-collision TTC2 of the left-hand end portion of the bicycle BC, and a time-to-collision TTC3 of the central portion of the bicycle BC respectively from the following equations (8), (9), and (10).

TTC1=d1/V_{B} (8)

TTC2=d2/V_{B} (9)

TTC3=d3/V_{B} (10)

Then, the control unit 22 adopts a value of a smallest one of the times to collision TTC1, TTC2, and TTC3 as a result of the calculation of the time-to-collision TTC.

After the control unit 22 ends the calculation of the time-to-collision TTC in S40, as shown in FIG. 2, the control unit 22 advances the process to S50.

In S50, the control unit 22 determines whether the outside temperature is equal to or less than a predetermined value TL. Specifically, the control unit 22 acquires the outside temperature detected by the outside-temperature sensor 31, and then determines whether this outside temperature is equal to or less than the predetermined value TL. Then, when the control unit 22 determines in S50 that the outside temperature is equal to or less than the predetermined value TL, the control unit 22 determines that a low-friction situation has occurred. The low-friction situation refers to a situation where a road-surface frictional coefficient of a road on which the own vehicle is traveling becomes low. Note that, when a minimum value of the road-surface frictional coefficient, at which a traveling speed and a traveling direction of the own vehicle can be changed as expected by automatic braking and automatic steering, is a minimum μ, the predetermined value TL is set as below. The predetermined value TL is set to a value equal to an outside temperature at which the road-surface frictional coefficient probably reaches the minimum μ due to, for example, snow accumulation on a surface of the road or freezing of the road surface, or set to a value of a temperature lower than the outside temperature. For example, the predetermined value TL is −7° C.

After the control unit 22 ends the process of S50, in S60, the control unit 22 determines, based on the result of the determination in S50, whether the outside temperature is equal to or less than the predetermined value TL, and, if the control unit 22 determines that the outside temperature is equal to or less than the predetermined value TL, that is, the low-friction situation has occurred, the control unit 22 advances the process to S70. Then, after the control unit 22 executes in S70 a changing process described below, the control unit 22 advances the process to S80. Note that, the changing process of S70 is a process for changing conditions for performing the automatic braking and the automatic steering such that the automatic braking and the automatic steering are started at timings earlier than those in a normal time. In contrast, if the control unit 22 determines in S60 that the outside temperature is not equal to or less than the predetermined value TL, that is, the low-friction situation has not occurred, the control unit 22 causes the process to skip S70 and proceed to S80.

In S80, based on the time-to-collision TTC calculated in S40 and a traveling speed V of the own vehicle (hereinafter, referred to as own-vehicle speed), which has been acquired by another process, the control unit 22 determines whether to perform an avoidance operation. Note that, the control unit 22 acquires the own-vehicle speed V, for example, at fixed intervals from the brake ECU 3.

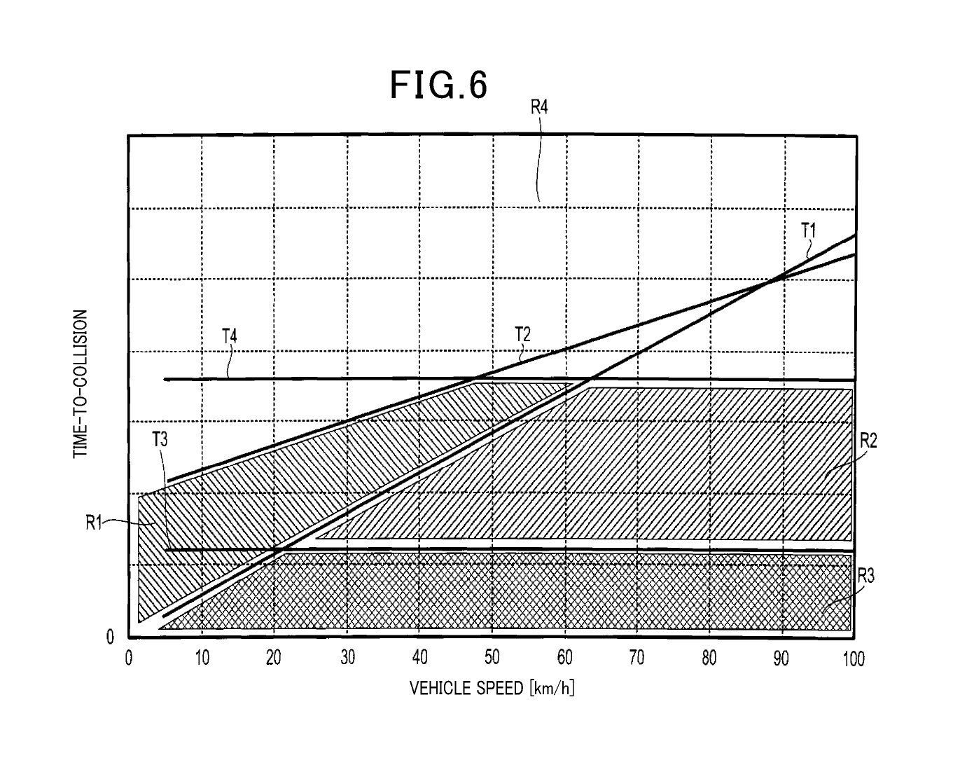

Specifically, as shown in FIG. 6, combinations of the time-to-collision TTC and the own-vehicle speed V are classified into a first region R1, a second region R2, a third region R3, and a fourth region R4. Note that, in FIG. 6, a value of “TIME-TO-COLLISION” increases toward an upper end of the vertical axis.

The first region R1 and the second region R2 are regions where the collision is avoided by the braking device 16. Note that, specifically, “collision is avoided” refers to avoidance of a collision between the forward object and the own vehicle. Further, “collision is avoided” is referred to also as “collision avoidance” or simply as “avoidance.”

The third region R3 is a region where a collision is avoided by the braking device 16 and the steering device 12, which corresponds to a time when ones of the combinations of the time-to-collision TTC and the own-vehicle speed V, which are in the second region R2, shift into the third region R3. Further, the third region R3 is also a region where a collision is avoided by the braking devices 16, which corresponds to a time when other ones of the combinations of the time-to-collision TTC and the own-vehicle speed V, which are in the first region R1, shift into the third region R3.

The fourth region R4 is a region where the avoidance assistance by the collision avoidance apparatus 1 is not performed.

Further, the regions R1, R2, R3, and R4 are determined depending on a braking-avoidance limit period T1, a normal-braking-avoidance lower-limit period T2, a steering-avoidance limit period T3, and a normal-steering-avoidance lower-limit period T4.

The braking-avoidance limit period T1 is a shortest time-to-collision within which a collision can be avoided by actuation of the braking device 16, which is proportionate to a relative speed with respect to the forward object. In other words, in a case where a driver starts a brake operation in a situation where the time-to-collision TTC is less than the braking-avoidance limit period T1, it is highly probable that a collision cannot be avoided only by the brake operation.

The normal-braking-avoidance lower-limit period T2 is a shortest time-to-collision within which the driver of the own vehicle starts the brake operation for avoiding a collision, which is proportionate to the relative speed with respect to the forward object.

The steering-avoidance limit period T3 is a shortest time-to-collision within which a collision can be avoided by the steering operation, which is a fixed value independent of the relative speed with respect to the forward object. In other words, in a case where the driver starts the steering operation in a situation where the time-to-collision TTC is less than the steering-avoidance limit period T3, it is highly probable that a collision cannot be avoided only by the steering operation.

The normal-steering-avoidance lower-limit period T4 is a shortest time-to-collision within which the driver of the own vehicle starts the steering operation for avoiding a collision, which is a fixed value independent of the relative speed with respect to the forward object.

Further, the first region R1 is a region where the corresponding ones therein of the combinations of the time-to-collision TTC and the own-vehicle speed V are less than the normal-braking-avoidance lower-limit period T2, less than the normal-steering-avoidance lower-limit period T4, and equal to or more than the braking-avoidance limit period T1.

The second region R2 is a region where the corresponding ones therein of the combinations of the time-to-collision TTC and the own-vehicle speed V are less than the braking-avoidance limit period T1, less than the normal-steering-avoidance lower-limit period T4, and equal to or more than the steering-avoidance limit period T3.

The third region R3 is a region where the corresponding ones therein of the combinations of the time-to-collision TTC and the own-vehicle speed V are less than the braking-avoidance limit period T1, and less than the steering-avoidance limit period T3.

The fourth region R4 is a region out of the regions R1, R2, and R3.

Further, for example, the memory 23 stores, as information items of the regions R1 to R4, a normal region map which is a data map indicating, as shown in FIG. 6, relationships between the periods T1 to T4 and the own-vehicle speed V.

In S80, when a current combination of the time-to-collision TTC and the own-vehicle speed V (hereinafter, referred to as own-vehicle status) falls within the first region R1 or the second region R2, the control unit 22 determines that a situation where avoidance is to be performed by braking has occurred.

Further, also when the own-vehicle status falls within the third region R3, and when the own-vehicle status has shifted from the first region R1 into the third region R3, the control unit 22 determines that the situation where avoidance is to be performed by braking has occurred.

Still further, when the own-vehicle status falls within the third region R3, and when the own-vehicle status has shifted from the second region R2 into the third region R3, the control unit 22 determines that a situation where avoidance is to be performed by braking and steering has occurred. In other words, in this case, the control unit 22 determines that the situation where avoidance is to be performed by braking has occurred, and that a situation where avoidance is to be performed by steering has occurred.

Further, when the own-vehicle status is within the fourth region R4, the control unit 22 determines that a situation where the avoidance operation is not to be performed has occurred. Such determinations are the determinations as to whether to perform the avoidance operation.

After the control unit 22 ends the process of S80, as shown in FIG. 2, in S85, the control unit 22 determines, based on the results of the determination in S80, whether the situation where an avoidance is to be performed by steering has occurred.

If the control unit 22 determines in S85 that the situation where avoidance is to be performed by steering has not occurred, the control unit 22 advances the process directly to S110, but if the control unit 22 determines in S85 that the situation where avoidance is to be performed by steering has occurred, the control unit 22 advances the process to S90.

In S90, the control unit 22 determines whether a preset steering-avoidance-unsuitability condition has been established. This steering-avoidance-unsuitability condition includes one or both of a condition that, in the traveling direction on a travel road, houses exist along the road, and a condition that, in the traveling direction on the travel road, there is a significant difference in height between the road and the outside of the road. The travel road refers to a road on which the own vehicle is traveling. In this S90, for example, with use of the road-map data item acquired from the navigation device 5, the control unit 22 determines whether the steering-avoidance-unsuitability condition has been met.

When the control unit 22 determines in S90 that the steering-avoidance-unsuitability condition has been met, the control unit 22 advances the process directly to S110.

In contrast, if the control unit 22 determines in S90 that the steering-avoidance-unsuitability condition has not been met, the control unit 22 advances the process to S100.

The control unit 22 performs in S100 collision-avoidance steering control as control of the automatic steering (that is, automatic-steering control) for causing the steering device 12 to change the traveling direction of the own vehicle such that collision avoidance is performed, and then the control unit 22 advances the process to S110. Specifically, in the collision-avoidance steering control of S100, the control unit 22 controls the steering device 12 so as to cause the own vehicle to move in the lateral direction by the lateral avoidance amount Xa within the time-to-collision TTC. Further, although the control of the steering device 12 is performed via the steering ECU 2, the steering device 12 may be configured to be directly controlled in response to a control signal from the collision avoidance apparatus 1.

In S110, based on the results of the determination in S80, the control unit 22 determines whether the situation where avoidance is to be performed by braking has occurred. If the control unit 22 determines in S110 that the situation where avoidance is to be performed by braking has not occurred, the control unit 22 temporarily ends the collision avoidance process.

In contrast, if the control unit 22 determines in S110 that the situation where avoidance is to be performed by braking has occurred, the control unit 22 advances the process to S120.

The control unit 22 performs in S120 collision-avoidance braking control as control of the automatic braking (that is, automatic-braking control) for causing the braking device 16 to reduce the traveling speed of the own vehicle such that the collision avoidance is performed, and then the control unit 22 temporarily ends the collision avoidance process. Specifically, in the collision-avoidance braking control of S120, the control unit 22 controls the braking device 16 so as to cause the own vehicle to be braked at a preset deceleration. In the collision-avoidance braking control of S120, the control unit 22 may control the braking device 16 such that the own vehicle is stopped within the time-to-collision TTC. Although the control of the braking device 16 is performed via the brake ECU 3, the braking device 16 may be configured to be directly controlled in response to the control signals from the collision avoidance apparatus 1.

Hereinafter, the changing process to be executed in S70 will be described.

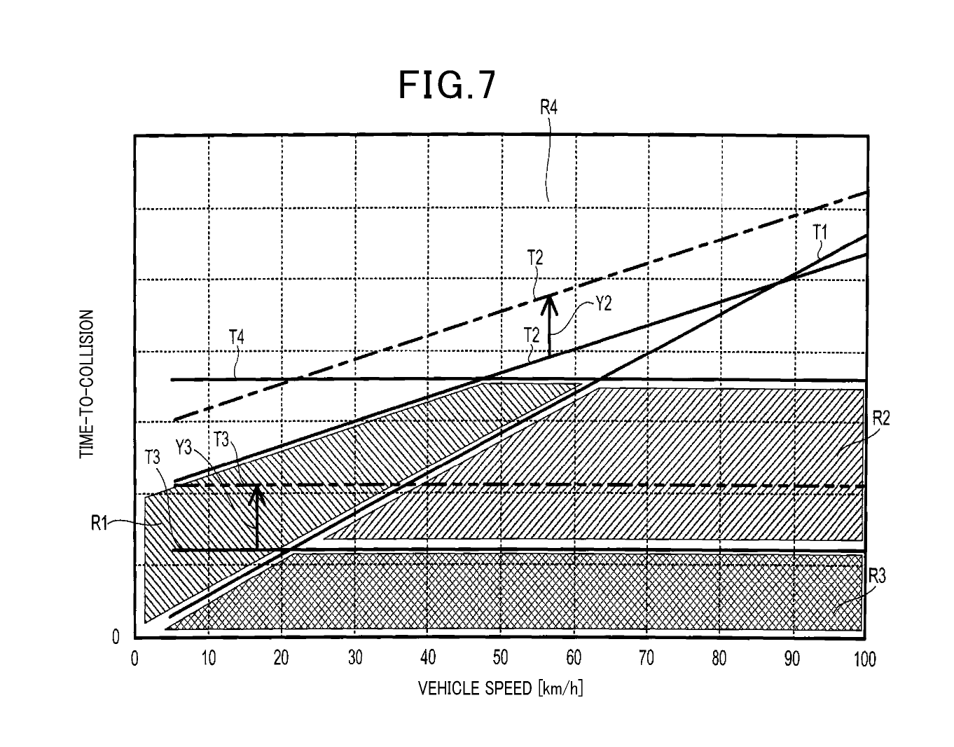

In S70, as indicated by an arrow Y2 in FIG. 7, the control unit 22 corrects values of the normal-braking-avoidance lower-limit period T2, which is recorded in the normal region map, to be larger by a predetermined value with respect to the entire range of the own-vehicle speed V. Further, as indicated by an arrow Y3 in FIG. 7, the control unit 22 corrects values of the steering-avoidance limit period T3, which is recorded in the normal region map, to be larger by a predetermined value with respect to the entire range of the own-vehicle speed V. In FIG. 7, an alternate long and short dash line indicates the normal-braking-avoidance lower-limit period T2 that has been increased by the correction, and an alternate long and two short dashes line indicates the steering-avoidance limit period T3 that has been increased by the correction. Then, the control unit 22 prepares, as a corrected region map, a data map in which the normal-braking-avoidance lower-limit period T2 and the steering-avoidance limit period T3 in the normal region map are replaced respectively with the periods T2 and T3 that have been increased by the correction. Note that, the values by which the periods T2 and T3 are respectively increased may be unequal to each other, or may be equal to each other.

Thus, if the control unit 22 determines in S60 that the low-friction situation has occurred, in S80, with use of the corrected region map prepared by the changing process of S70, the control unit 22 makes the above-described determinations as to whether to perform the avoidance operation. In contrast, if the control unit 22 determines in S60 that the low-friction state has not occurred, in S80, with use of the normal region map including the uncorrected periods T2 and T3, the control unit 22 makes the above-described determinations as to whether to perform the avoidance operation.

Thus, if the control unit 22 determines in S60 that the low-friction situation has occurred, the control unit 22 performs the collision-avoidance braking control and the collision-avoidance braking control at time points earlier than those in the times to collision TTC longer than those in the normal time when the control unit 22 determines in S60 that the low-friction state has not occurred.

Specifically, when it is determined in S60 that the low-friction situation has occurred, the values of the normal-braking-avoidance lower-limit period T2 are changed to be larger than those in the normal time, and hence, at time points corresponding to these larger values, the times to collision TTC fall within the first region R1. Thus, at the earlier time points in the longer times to collision TTC, the control unit 22 determines that the situation where avoidance is to be performed by braking has occurred, and then performs the collision-avoidance braking control.

Similarly, if it is determined in S60 that the low-friction situation has occurred, the values of the steering-avoidance limit period T3 are changed to be larger than those in the normal time, and hence, at time points corresponding to these larger values, the ones of the times to collision TTC, which are in the second region R2, transfer into the third region R3. Thus, at the earlier time points in the longer times to collision TTC, the control unit 22 determines that the situation where avoidance is to be performed by steering has occurred, and then performs the collision-avoidance steering control.

Thus, when it is determined in S60 that the low-friction situation has occurred, the collision-avoidance braking control and the collision-avoidance steering control are started at timings earlier than those in the normal time.

In addition, when it is determined in S60 that the low-friction situation has occurred, output of the collision-avoidance braking control and output of the collision-avoidance steering control are reduced to be lower than those in the normal time.

In the collision-avoidance steering control, the steering device 12 is controlled such that the own vehicle moves in the lateral direction by the lateral avoidance amount Xa within the time-to-collision TTC. Thus, the collision-avoidance steering control is started at the earlier time points in the longer times to collision TTC, whereby the output of the collision-avoidance steering control, that is, the steering angle that is formed by the steering device 12 to be controlled is reduced.

In the collision-avoidance braking control, the braking device 16 is controlled such that the own vehicle is stopped within the time-to-collision TTC. Thus, the collision-avoidance braking control is started at the earlier time points in the longer times to collision TTC, whereby the output of the collision-avoidance braking control, that is, the braking force that is generated by the braking device 16 to be controlled is reduced.

### [1-3. Advantages]

The collision avoidance apparatus 1 according to the first embodiment provides the following advantages.

(1a) When the control unit 22 determines in S60 that the low-friction situation has occurred, the control unit 22 starts the collision-avoidance braking control and the collision-avoidance steering control as collision-avoidance control modes at the timings earlier than those in the normal time when the control unit 22 determines in S60 that the low-friction state has not occurred.

Thus, in a situation where the road-surface frictional coefficient is less than the above-described minimum μ, an advantage of the collision avoidance can be inhibited from being impaired. Further, even in a case where the collision cannot be avoided, an advantage of reducing damage from the collision can be expected.

(1b) In S70, the control unit 22 determines whether the outside temperature is equal to or less than the predetermined value TL, and, if the control unit 22 determines that the outside temperature is equal to or less than the predetermined value TL, the control unit 22 determines that the low-friction situation has occurred. In this way, the control unit 22 is capable of easily determining whether the low-friction state has occurred.

(1c) The control unit 22 uses, as a determination-subject outside temperature for the determination as to whether the outside temperature is equal to or less than the predetermined value TL, the outside temperature that has been detected by the outside-temperature sensor 31 provided to the own vehicle. Thus, accuracy of the determination as to whether the outside temperature is equal to or less than the predetermined value TL can be increased. The control unit 22 may be configured, for example, to acquire the determination-subject outside temperature from a terrestrial facility on the outside of the own vehicle via, for example, wireless communication, but the result of the determination can be much more reliably obtained when the result of the detection by the outside-temperature sensor 31 is used as the determination-subject outside temperature.

(1d) When the time-to-collision TTC that the control unit 22 repeatedly calculates at fixed intervals is less than the normal-braking-avoidance lower-limit period T2, the control unit 22 performs the collision-avoidance braking control which is one of the collision-avoidance control modes. Further, when the time-to-collision TTC is less than the steering-avoidance limit period T3, the control unit 22 performs the collision-avoidance steering control which is another one of the collision-avoidance control modes. Then, when the control unit 22 determines in 60 that the low-friction situation has occurred, the values of each of the periods T2 and T3 are changed to be larger, whereby the collision-avoidance control modes can be started at the earlier timings. In this way, processes for starting the collision-avoidance control modes at the earlier timings are simplified.

As a modification of starting the collision-avoidance control modes at the earlier timings, values of the normal-steering-avoidance lower-limit period T4 may be changed to be larger, or both the values of the normal-braking-avoidance lower-limit period T2 and the values of the normal-steering-avoidance lower-limit period T4 may be changed to be larger. Further, as the collision-avoidance control mode, only one of the automatic braking control (collision-avoidance braking control) and the automatic steering control (collision-avoidance steering control) may be performed. For example, as for a configuration in which the automatic steering control is not performed, S85 to S100 may be omitted from the collision avoidance process. Meanwhile, as for a configuration in which the automatic braking control is not performed, S110 and S120 may be omitted from the collision avoidance process. Further, there may be employed a configuration in which only one of the automatic braking control and the automatic steering control is started at the earlier timing.

Note that, in the first embodiment, the control unit 22 functions as an avoidance control unit, a situation determination unit, and a changing unit. In addition, S10 to S40 and S80 to S120 correspond to processes by the control unit 22, S50 corresponds to a process by the situation determination unit, and S70 corresponds to a process by the changing unit. Further, of the processes by the control unit 22, S40 corresponds to a process by a calculation unit. Still further, the collision-avoidance steering control of S100 corresponds to the automatic steering control, and the collision-avoidance braking control of S120 corresponds to the automatic braking control. Yet further, at least one of the normal-braking-avoidance lower-limit period T2 and the normal-steering-avoidance lower-limit period T4 corresponds to a predetermined value for determining the timing of starting the automatic braking control. Yet further, the steering-avoidance limit period T3 corresponds to a predetermined value for determining the timing of starting the automatic steering control.

### 2. Second Embodiment

### 2-1. Differences from First Embodiment

Basic configuration features of the second embodiment are similar to those of the first embodiment, and hence differences from the first embodiment will be described below. Note that, the same reference symbols as those in the foregoing first embodiment denote the same components.

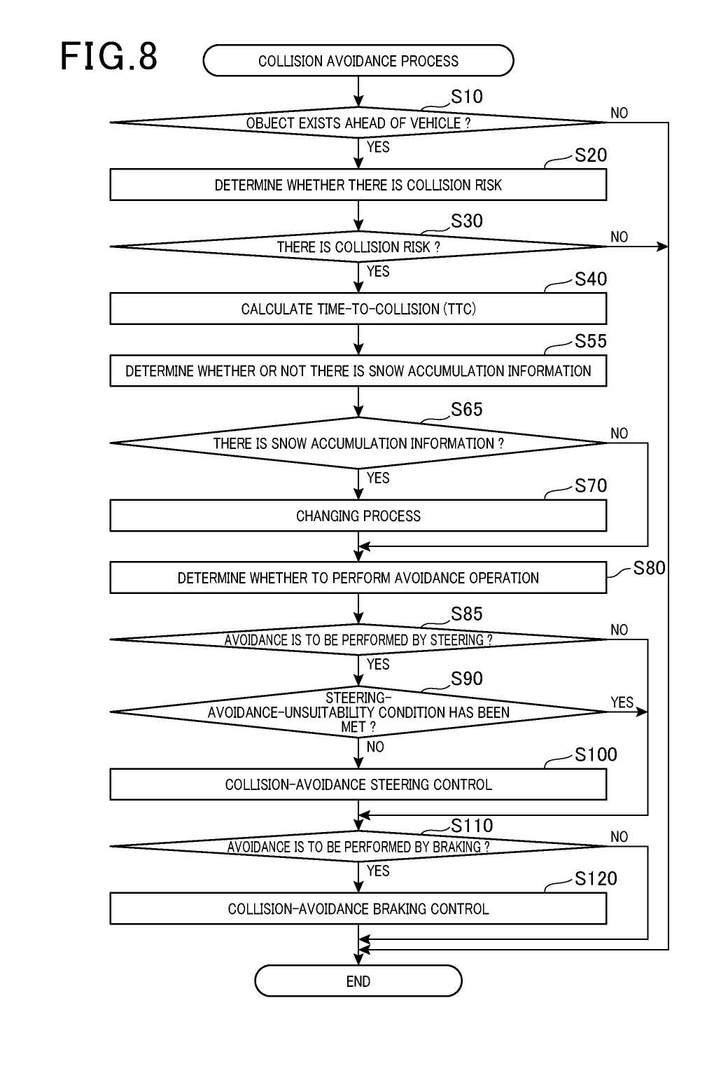

The collision avoidance apparatus 1 according to the second embodiment is different from that according to the first embodiment in that the control unit 22 executes a collision avoidance process of FIG. 8 instead of the collision avoidance process of FIG. 2.

Specifically, the collision avoidance process of FIG. 8 is different from the collision avoidance process of FIG. 2 in including S55 and S55 instead of S50 and S60.

As shown in FIG. 8, after the control unit 22 calculates the time-to-collision TIC in S40, the control unit 22 advances the process to S55.

In S55, the control unit 22 determines whether a snowfall information item indicating that it is snowing at a current position of the own vehicle (hereinafter, referred to as own-vehicle-position snowfall information item) has been acquired. Then, if the control unit 22 determines in S55 that the own-vehicle-position snowfall information item has been acquired, the control unit 22 determines that the low-friction situation has occurred.

Note that, as an example of the own-vehicle-position snowfall information item, there may be mentioned a snowfall information item indicating that it shows in units of predetermined regions where the own vehicle exists, such as a city, a town, and a village. Further, the snowfall information item, which is transmitted in a wireless manner from information providers such as a terrestrial broadcaster, is received by the navigation device 5. Then, the control unit 22 acquires the received snowfall-information item from the navigation device 5 via the communication line 6. From the navigation device 5 to the collision avoidance apparatus 1, among the received snowfall-information items, only the own-vehicle-position snowfall information item may be transmitted, or all the received snowfall-information items may be transmitted.

After the control unit 22 ends the process of S55, in S65, the control unit 22 determines, based on the result of the determination in S55, whether the own-vehicle-position snowfall information item has been acquired, and, if the control unit 22 determines that the own-vehicle-position snowfall information item has been acquired, that is, the low-friction situation has occurred, the control unit 22 advances the process to S70 described above. In contrast, if the control unit 22 determines in S65 that the own-vehicle-position snowfall information item has not been acquired, that is, the low-friction situation has not occurred, the control unit 22 causes the process to skip S70 and proceed to S80.

### 2-2. Advantages

In the collision avoidance apparatus 1 according to the second embodiment, when the own-vehicle-position snowfall information item is acquired, the control unit 22 determines that the low-friction situation has occurred, and starts the collision-avoidance braking control and the collision-avoidance steering control as the collision-avoidance control modes at the earlier timings. Thus, the same advantage as that described above in (1a) can be obtained. Further, as in the first embodiment, the control unit 22 is capable of easily determining whether the low-friction state has occurred. In addition, the advantage described above in (1d) also can be obtained.

Note that, in the second embodiment, S55 corresponds to the process by the situation determination unit.

### 3. Modification

Also with regard to a modification described below, basic configuration features thereof are similar to those of the first embodiment, and hence differences from the first embodiment will be described below. Further, the same reference symbols as those in the foregoing first embodiment denote the same components.

Even when the road-surface frictional coefficient is not low, for example, in a situation where output of an actuator that actuates the braking device 16, that is, output of the brake actuator 17 is restricted, the own-vehicle speed may not be reduced as expected by the automatic braking. Similarly, in a situation where output of an actuator that actuates the steering device 12, that is, output of the steering actuator 13 is restricted, the traveling direction may not be changed as expected by the automatic steering. In this way, in the situation where the output of the steering actuator 13 or the brake actuator 17 is restricted (hereinafter, referred to as output restriction situation), an advantage of the collision avoidance may not be sufficiently obtained.

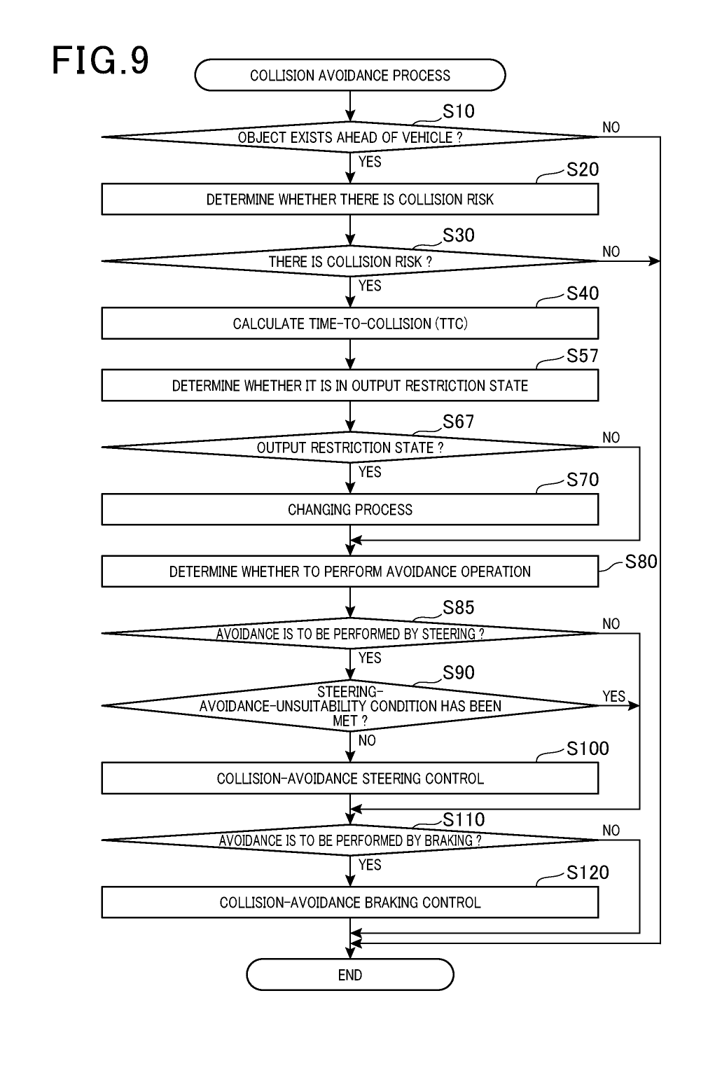

In view of such circumstances, the collision avoidance apparatus 1 according to the modification is differentiated from that according to the first embodiment in that the control unit 22 executes a collision avoidance process of FIG. 9 instead of the collision avoidance process of FIG. 2.

Specifically, the collision avoidance process of FIG. 9 is differentiated from the collision avoidance process of FIG. 2 in including S57 and S67 instead of S50 and S60.

As shown in FIG. 9, after the control unit 22 calculates the time-to-collision TTC in S40, the control unit 22 advances the process to S57.

In S57, the control unit 22 determines whether the steering actuator 13 and the brake actuator 17 are in the output restriction state.

For example, when a temperature of the steering actuator 13, which is monitored by the steering ECU 2, is equal to or higher than a preset value, the steering ECU 2 enters an operation mode in which the output of the steering actuator 13 is restricted to prevent the temperature from increasing (hereinafter, referred to as output restriction mode). Then, when the steering ECU 2 enters the output restriction mode, the steering ECU 2 transmits an output-restriction information item for overheat protection to the collision avoidance apparatus 1. Thus, when the control unit 22 acquires the output-restriction information item from the steering ECU 2, the control unit 22 determines that the steering actuator 13 is in the output restriction state.

Similarly, when a temperature of the brake actuator 17, which is monitored by the brake ECU 3, is equal to or higher than a preset value, the brake ECU 3 enters the output restriction mode in which the output of the brake actuator 17 is restricted to prevent the temperature from increasing. Then, when the brake ECU 3 enters the output restriction mode, the brake ECU 3 transmits the output-restriction information item for the overheat protection to the collision avoidance apparatus 1. Thus, when the control unit 22 acquires the output-restriction information item from the brake ECU 3, the control unit 22 determines that the brake actuator 17 is in the output restriction state.

Further, power sources for the actuators 13 and 17 are a battery voltage of the own vehicle, and hence, also when the battery voltage is equal to or less than a predetermined value, the actuators 13 and 17 cannot generate their output 100%. In other words, the actuators 13 and 17 are in the output restriction states. Thus, also when the control unit 22 determines that the battery voltage is equal to or less than the predetermined value, the control unit 22 determines that the actuators 13 and 17 are in the output restriction states. Note that, the control unit 22 may be configured to make only one of the determination based on the output-restriction information items and the determination based on the battery voltage.

After the control unit 22 ends the process of S57, in S67, the control unit 22 determines, based on a result of the determination in S57, whether either one of the actuators 13 and 17 is in the output restriction state.

Then, if the control unit 22 determines that neither one of the actuators 13 and 17 is in the output restriction state, the control unit 22 causes the process to skip S70 and proceed to S80, but if the control unit 22 determines that either one of the actuators 13 and 17 is in the output restriction state, the control unit 22 advances the process to S70.

Then, in S70, the control unit 22 executes the above-described changing process, thereby starting the collision-avoidance braking control and the collision-avoidance steering control at the earlier timings. Note that, when the control unit 22 determines in S70 that only the brake actuator 17 of the actuators 13 and 17 is in the output restriction state, the control unit 22 may start the collision-avoidance braking control at the earlier timing, for example, by changing the values of the above-described period T2 to larger values. In contrast, when the control unit 22 determines in S70 that only the steering actuator 13 of the actuators 13 and 17 is in the output restriction state, the control unit 22 may start the collision-avoidance steering control at the earlier timing, for example, by changing the values of the above-described period T3 to larger values.

Also by the collision avoidance apparatus 1 as described above in this modification, the advantage of the collision avoidance can be inhibited from being impaired. Further, the advantage described above in (1d) also can be obtained.

### 4. Other Embodiments

With regard to the description of the embodiments of the present disclosure, the present disclosure is not limited to the above-described embodiments, and may be carried out in various modifications.

For example, a detection unit that detects a forward object is not limited to the radar device 4, and may be an object detection device such as a sonar or a camera.

Further, a plurality of functions of one component in the above-described embodiments may be implemented by a plurality of components, or one function of one component may be implemented by a plurality of components. Alternatively, a plurality of functions of a plurality of components may be implemented by one component, or a single function to be implemented by a plurality of components may be implemented by one component. Still further, part of the configurations of the above-described embodiments may be omitted. Yet further, at least part of the configurations of the above-described embodiments may be added to the configurations of the other above-described embodiments or replaced with another part of the configurations of the other above-described embodiments. Note that, aspects encompassed within the technical idea specified by the wording of the claims include the embodiments of the present disclosure.

Further, the present disclosure is not limited to the above-described collision avoidance apparatus, and may encompass various other embodiments such as a system including the collision avoidance apparatus as a component, a program for allowing a computer to function as the collision avoidance apparatus, a non-transitory tangible storage medium storing this program, such as a semiconductor memory, and a collision avoidance method.

1. A vehicle control apparatus comprising:
an avoidance control unit configured to perform, as collision-avoidance control for causing an object that exists ahead of an own vehicle, which is a vehicle in which the vehicle control apparatus is installed, and the own vehicle to avoid a collision with each other, one or both of automatic steering control for changing a traveling direction of the own vehicle by controlling a steering device of the own vehicle, and automatic braking control for reducing a traveling speed of the own vehicle by controlling a braking device of the own vehicle;
a determination unit configured to determine whether an actuator for performing the collision-avoidance control is in an output restriction state in which output of the actuator is restricted; and
a changing unit configured to cause the avoidance control unit to start the collision avoidance control at an earlier timing at a time when the determination unit determines that the actuator is in the output restriction state than a timing at a time when the determination unit determines that the actuator is not in the output restriction state.

2. (canceled)

3. The vehicle control apparatus according to claim 1,
wherein
the determination unit is configured to, when a device that drives the actuator when a temperature of the actuator is equal to or higher than a preset value is in an operation mode in which output of the actuator is restricted, determine that the actuator is in the output restriction state.

4. The vehicle control apparatus according to claim 1, wherein
the determination unit is configured to, when a battery voltage which is a power source of the actuator is equal to or less than a predetermined value, determine that the actuator is in the output restriction state.

5. (canceled)

6. The vehicle control apparatus according to claim 1, wherein
the avoidance control unit includes a calculation unit configured to repeatedly calculate a time-to-collision which is a predictive value of a period until the collision between the own vehicle and the object, and is configured to perform the collision avoidance control if the time-to-collision calculated by the calculation unit is less than a predetermined value, and
the changing unit is configured to change, if the determination unit determines that the actuator is in the output restriction state, the predetermined value to a value that is larger than a value at the time when the determination unit determines that the actuator is not in the output restriction state, thereby causing the avoidance control unit to start the collision avoidance control at the earlier timing.
